(19) United States
(12) Patent Application Publication
(10) Pub. No.: US 2012/0110003 A1
(43) Pub. Date: May 3, 2012

(54) CONDITIONAL EXECUTION OF REGULAR EXPRESSIONS

(75) Inventors: Jason E. Brewer, Kirkland, WA (US); Charles W. Lamanna, Bellevue, WA (US); Mauktik H. Gandhi, Redmond, WA (US)

(73) Assignee: MICROSOFT CORPORATION, Redmond, WA (US)

(21) Appl. No.: 12/938,895

(22) Filed: Nov. 3, 2010

(51) Int. Cl. G06F 17/30

(52) U.S. Cl. 707/769; 707/E17.014

(57) ABSTRACT

Embodiments directed to conditionally executing regular expressions and to simplifying regular expressions by canonicalizing regular expression terms. In an embodiment, a computer system accesses identified regular expression key terms that are to appear in a selected portion of text. The regular expression key terms are identified from terms in a selected regular expression. The computer system determines whether the identified regular expression key terms appear in the selected portion of text. The computer system also, upon determining that none of the identified regular expression key terms appears in the selected portion of text, prevents execution of the regular expression. Upon determining that at least one of the identified regular expression key terms appears in the selected portion of text, the computer system executes the regular expression.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications may be designed to parse the text of documents, emails or other strings of characters. In such cases, regular expressions may be used to identify words, phrases or certain characters within the text. For instance, spam filters may use regular expressions to scan for certain words or phrases in email messages that are commonly associated with unwanted spam messages. In other cases, regular expressions may scan for strings of numbers or other characters. These regular expressions, however, may be very large and complicated. Processing these complicated regular expressions may consume considerable amounts of processing resources.

### BRIEF SUMMARY

Embodiments described herein are directed to conditionally executing regular expressions and to simplifying regular expressions by canonicalizing regular expression terms. In one embodiment, a computer system accesses identified regular expression key terms that are to appear in a selected portion of text. The regular expression key terms are identified from terms in a selected regular expression. The computer system determines whether the identified regular expression key terms appear in the selected portion of text. The computer system also, upon determining that none of the identified regular expression key terms appears in the selected portion of text, prevents execution of the regular expression. Upon determining that at least one of the identified regular expression key terms appears in the selected portion of text, the computer system executes the regular expression.

In another embodiment, a computer system accesses regular expression terms in a regular expression. The regular expression is configured for finding desired characters sets in a document. The computer system determines that some of the regular expression terms are to be canonicalized. Based on the determination, the computer system canonicalizes the regular expression terms, so that at least one previously uncanonicalized regular expression term is simplified into a single, canonicalized term.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including conditionally executing regular expressions and simplifying regular expressions by canonicalizing regular expression terms.

FIG. 2 illustrates a flowchart of an example method for conditionally executing regular expressions.

FIG. 3 illustrates a flowchart of an example method for simplifying regular expressions by canonicalizing regular expression terms.

FIG. 4 illustrates a computer architecture in which text is canonicalized and implemented in regular expressions.

### DETAILED DESCRIPTION

Embodiments described herein are directed to conditionally executing regular expressions and to simplifying regular expressions by canonicalizing regular expression terms. In one embodiment, a computer system accesses identified regular expression key terms that are to appear in a selected portion of text. The regular expression key terms are identified from terms in a selected regular expression. The computer system determines whether the identified regular expression key terms appear in the selected portion of text. The computer system also, upon determining that none of the identified regular expression key terms appears in the selected portion of text, prevents execution of the regular expression. Upon determining that at least one of the identified regular expression key terms appears in the selected portion of text, the computer system executes the regular expression.

In another embodiment, a computer system accesses regular expression terms in a regular expression. The regular expression is configured for finding desired characters sets in a document. The computer system determines that some of the regular expression terms are to be canonicalized. Based on the determination, the computer system canonicalizes the regular expression terms, so that at least one previously uncanonicalized regular expression term is simplified into a single, canonicalized term.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

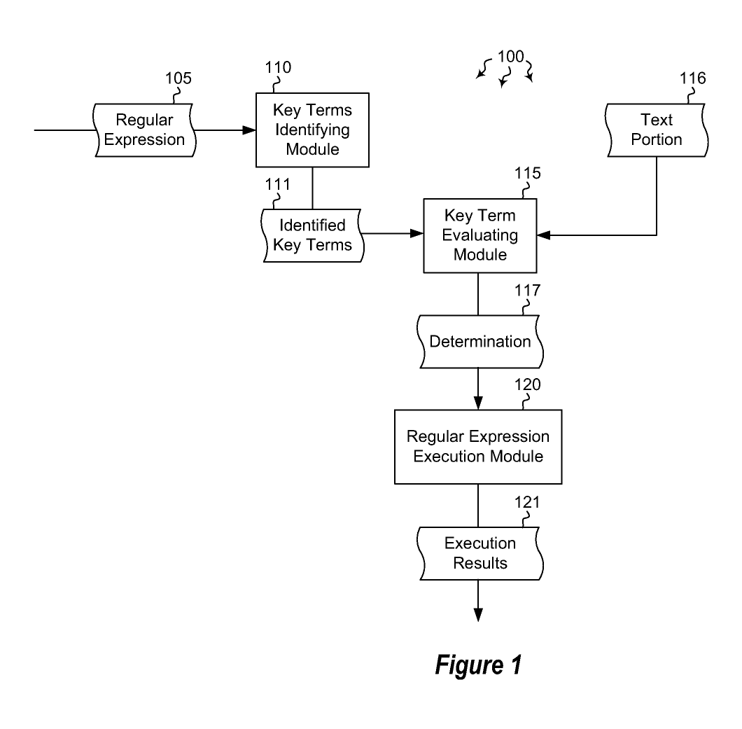

FIG. 1 illustrates a computer architecture 100 in which the principles of the present invention may be employed. Computer architecture 100 includes regular expression 105. As used herein, the term regular expression refers to terms, symbols, special characters, words, phrases or other sequences of characters that are used to identify other terms, phrases, words, numbers or other characters in a block of text. For instance, a regular expression may include certain characters that are designed to look for important information such as credit card numbers, social security numbers, names and addresses and other personal information. Such regular expressions may be implemented to assist in data leakage prevention programs that prevent users from sending such personal information in open text emails or other documents.

Regular expressions (e.g. 105) may include substantially any number of terms or special characters. Key terms identifying module 110 may be used to identify one or more key terms 111 in the regular expression. Key terms, as used herein, may include regular expression terms that are fundamental to that regular expression. In other words, without that key term or terms, the regular expression will not match and the rest of the regular expression does not need to be applied. Accordingly, in the example mentioned above, if a regular expression is designed to look for “Credit Card” (e.g. “Credit Card:.*?\d{16}” with key term {“Credit Card”}), if the word “Credit Card” was not found in the text, the regular expression would not match. Moreover, because the regular expression did not match, the text would not need to be searched for the other information.

Key term evaluating module 115 may access text portion 116, which may be an email, document, web page or any other file or item that includes text. Module 115 may evaluate the text portion to determine whether it has any of the identified key terms 111 of the regular expression that is being used (105). Determination 117 indicates that the identified key terms were either present in the text portion, or were not present in the text portion. Based on this determination, regular expression execution module 120 may either prevent execution in cases where the key terms were not present in the text portion, or may initiate execution in cases where the key terms were present in the text portion. In cases where the regular expression was executed, the execution results 121 may be sent to a user, computer system, software application or other entity.

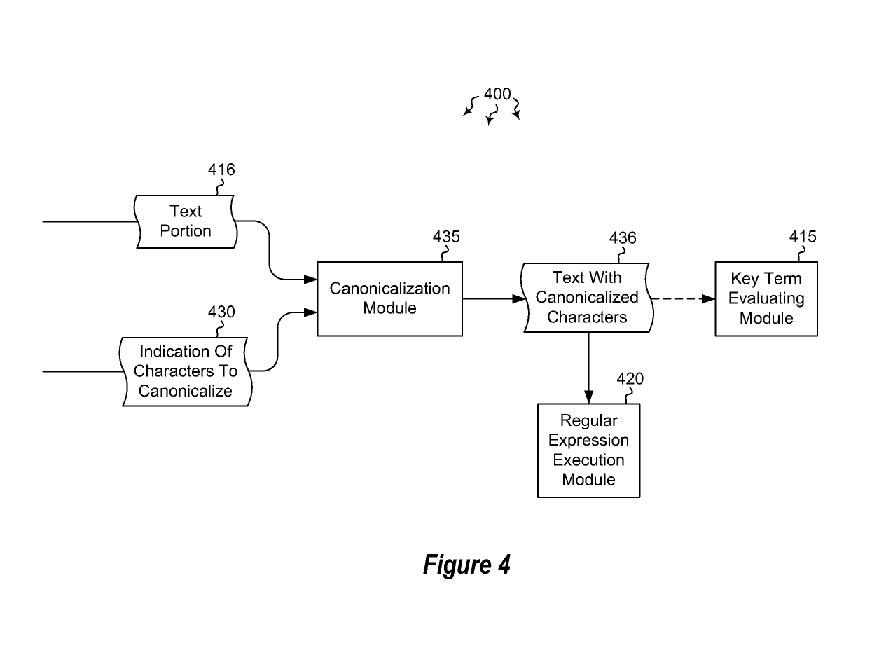

FIG. 4 includes a canonicalization module 435. The term “canonicalize,” as used herein, refers to identifying a set of characters and converting those characters to a single character during text processing. For instance, in one embodiment, any Arabic number (0-9) may be treated as (or converted to) a 0. Thus, in the credit card example above, the regular expression would not need to match certain specific strings of numbers, but rather sixteen sequential zeros which represent each number 0-9. Many other implementations of canonicalization may be used, and this example should not be read as limiting the types of canonicalization that are possible.

Canonicalization module 435 may access a portion of text 416 and an indication of characters that are to be canonicalized 430. This indication may be received from a user, computer system, software application or other entity. Based on the indication, module 435 may canonicalize the characters as instructed and output the text with canonicalized characters 436. This text with canonicalized characters may be sent to the key term evaluating module 415 to determine whether the text includes any of the identified key terms. Additionally or alternatively, the text with canonicalized characters may be sent to regular expression execution module 420 to be analyzed by a regular expression.

In this manner, regular expressions may be statically analyzed to extract key terms, and then conditionally executed if those key terms are present. This enables very complex regular expressions to be used. As long as part of the regular expression may be found to require any of a set of key terms to match, the rest of the regular expression may be highly sophisticated. This allows existing corpuses of regular expressions to be used, some of which may be very complex.

Preprocessing of regular expressions may be used to generate a conditional regular expression. In some cases, preprocessing may be performed once on each regular expression in the corpus. The results may be saved and then consumed during the execution stage. Preprocessing is designed to extract terms from a regular expression, in order to speed up the execution stage. Canonicalization may be performed during preprocessing.

In some embodiments, alternation or operators which may result in multiple matches result in multiple generated terms. For instance, “this|that” results in the terms ‘this’ and ‘that’. If an operator cannot be turned into a term (or would result in too many terms), groups of terms may be created. For example, “this \w* that” may result in the term group {‘this’, ‘that’} (\w* does not generate any finite set of terms). Groups may be parsed separately, and then merged with the remaining results. For instance, “Test (stuff|data) text” results in {‘stuff, data’ } being produced from the contained group, then being merged into the parent group, to produce {‘Test stuff text’, ‘Test data text’}.

The following examples are for illustration purposes only and should not be read as limiting the scope of the invention. In these examples, the following terminology will apply: Given n regular expressions and i|0≦i≦n, let Rᵢ be the ith regular expression. A target document on which regular expressions are to be executed is D. Characters which (after canonicalization) are useful in key terms are aggregated and combined into the set Sᵢ. Sᵢ includes groups of terms gⱼ. Each generated Sᵢ is grouped into T (e.g. T={Sᵢ|0≦i≦n}). If the regular expression could not be parsed, or resulted in too many terms, Sᵢ is empty (meaning Rᵢ would always be executed).

When executing on a document, all terms within a document D are searched (e.g. any member of any of the groups S) using a searching algorithm such as Aho-Corasick, which can match any of the terms in T in one pass (e.g. can find the set of all terms in any Sᵢ which occurred in D). Rᵢ may match if Sᵢ matches, and never matches if Sᵢ does not match. Sᵢ matches if any group of terms g under it matches or it is empty. “g” matches if each of the terms in g occurred in D.

When Sᵢ did not match, the regular expression did not match. This may occur in many scenarios (for regular expressions detecting credit cards, for example, most documents do not contain credit cards, and so the regular expressions will usually not match). When Sᵢ does match, one of the following may happen: 1) The regular expression was fully processed while extracting key terms. Then Rᵢ matched if and only if Sᵢ matched, 2) The regular expression was partially processed, start and end lengths are known. Then, searches may be performed within a constrained range within D for Rᵢ. Or 3) The regular expression was partially processed, and start and end lengths are not known. Then Rᵢ on D will be run. If Sᵢ was empty (couldn't be generated), Rᵢ is executed on D. Thus, Rᵢ is conditionally executed through use of Sᵢ.

Performance gains may be significant for parsed regular expressions. “n” regular expressions run on a document of length m in O(n*m) time, while n (successfully preprocessed) conditional regular expressions can run in O(m) time (in the case where either the regular expressions were fully processed, or did not match the document). For many cases, like data leakage protection and anti-spam, most regular expressions do not match any given document, and thus processing for many regular expressions may be avoided.

Canonicalization, as mentioned above, is the process of converting a set of characters to a single character during document processing. The choice of which characters to canonicalize may vary heavily based on implementation. The conversion may be performed both while processing the regular expression (at which point a match of any character in the set instead matches the single character), and while searching for terms within the document (at which point any character in the set is converted). This process can broaden the number of regular expressions which can be successfully converted into conditional regular expressions. Moreover, the preprocessed regular expressions can be executed significantly faster than normal regular expressions.

In some cases, data leakage protection regular expressions are very heavily number oriented. Canonicalizing based on numbers can significantly increase the number of regular expressions which can be preprocessed. For instance, when reading a document, any Arabic number (0 through 9) might be treated as a 0. When this is done, it collapses the number of terms needed to match a regular expression substantially. For instance, [0-9]{3} generates a large number of terms before canonicalization (and a primitive regular expression to match social security numbers, like [0-9]{3}−[0-9]{2}−[0-9]{4}, generates many more). After canonicalization, these become 000 and 000-00-0000, respectively. As most documents do not have such strings of numbers, most regular expressions searching for such strings do not match any given document.

Other examples of where term canonicalization may be useful include numbers, consecutive whitespace characters, languages (Unicode code blocks), alphabetical characters (for example a-z), symbols (canonicalize common textual symbols, like $%̂), case (make everything lowercase), or any well-defined set of characters (e.g. abcdef may map to 0, for regular expressions where finding hexadecimal numbers is important). Terms that use canonicalization may not fully parse regular expressions; thus, if the term set matches, Ri will need to be executed.

Extracting terms from the regular expressions happens by processing the regular expression itself. When a character is encountered which is matchable within a relatively small set of characters (the size of this may be customizable) (for example, [0-9] can be any of 10 possibilities, in an ASCII regular expression, 4 can be 26 or 52 (depending on if the match is case insensitive), and in a Unicode regular expression, 4 can be several thousand characters. Consecutive matchable characters may be aggregated into a set of terms, until an item which cannot be added into a term is encountered (for example, \w*). The next matchable character begins a new set of terms. Grouping operators also cause term-sets to be grouped.

Groups are first processed individually, and then merged into the higher-level results. In processing “a(b(c|d)){2}”: “(c|d)” would be processed (producing {‘c’, ‘d’}), then “(b|(c|d)” would be processed (producing {‘bc’, ‘bd’}) and finally, the top level group would be processed, producing a final result of {‘abcbc’, ‘abcbd’, ‘abdbc’, ‘abdbd’}.

Once parsing is complete, a list of sets of terms is produced. Each set is then combined—if the number of terms becomes too large at any point, then the set is discarded. The combined sets are placed into groups (with another discard step when there are too many possibilities). The resultant set of groups of terms form Sᵢ. The examples below provide indications of how this is done.

### Example 1A

Canonicalization: none, Regular expression: This example.*text. After processing this, we find the following term-sets: ‘This’, ‘example’, ‘text’. These are combined into a single group {‘This’, ‘example’, ‘text’}. The start and end points of this regular expression are known (‘this’ and ‘text’), and so if Sᵢ matches, Rᵢ the regular expression can be run with a predefined start and ending point which is a subset of D (from the start of where ‘this’ was matched, to the end of where ‘text’ was matched).

### Example 1B

Canonicalization: lowercase, Regular expression: The example.*text. After processing this, the following term-sets are found: ‘the’, ‘example’, ‘text’. There are combined into a single group {‘the’, ‘example’, ‘text’}. The start and end points of this regular expression are known (‘the’ and ‘text’), and so if Sᵢ matches, Rᵢ can be run with a predefined start and ending point which is a subset of D.

### Example 2A

Canonicalization: none, Regular expression: where (is|are) the (people|person). After processing this, the following term-sets are found: ‘where’, {‘is’, ‘are’}, ‘the’, {‘people’, ‘person’}. These are combined and joined to form four terms: “where is the people”, “where is the person”, “where are the people”, “where are the person”. The regular expression was fully converted to terms. As such, the regular expression does not need to be executed, since the regular expression matched if and only if one of the terms matched.

### Example 2B

Canonicalization: lowercase, Regular expression: where ([Ii]s|are) the ([Pp]eople|[Pp]ersons?). After processing this, the following term-sets are found: ‘where’, {‘is’, ‘are’}, ‘the’, {‘people’, ‘person’, ‘persons’}. These are combined and joined to form six terms: “where is the people”, “where is the person”, “where is the persons”, “where are the people”, “where are the person”, “where are the persons”. The regular expression was fully converted to terms, but because of the canonicalization, this is not sufficient to ensure the regular expression matched. The regular expression needs to be executed to check if a match exists, but has given start and end points.

### Example 2C

Canonicalization: numbers, Regular expression: \w* who (will (go|\d)|\d{2}) \w* test. The deepest group (go|\d) is analyzed to produce ‘go’ and ‘0’, the next group up is analyzed to produce {‘will’, {‘go’, ‘0’}}, ‘00’}. Finally, the top level group is analyzed. The \w* is ignored as no terms can be built out of it. Once terms are combined, the following groups are produced: {‘who will go’, ‘test’}, {‘who will 0’, ‘test’}, and {‘who 00’, ‘test’}. The regular expression was not fully converted to terms, and the start point is not known. Thus, if the terms match, the regular expression would need to be run on the entire document to verify a match.

### Example 3

Canonicalization: none, Regular expression: (\w+\s+){3}\w+. The regular expression matches any four consecutive words, but none of this regular expression is able to be analyzed, and so no terms are produced. In this example, the regular expression needs to be executed to check for a match.

### Example 4

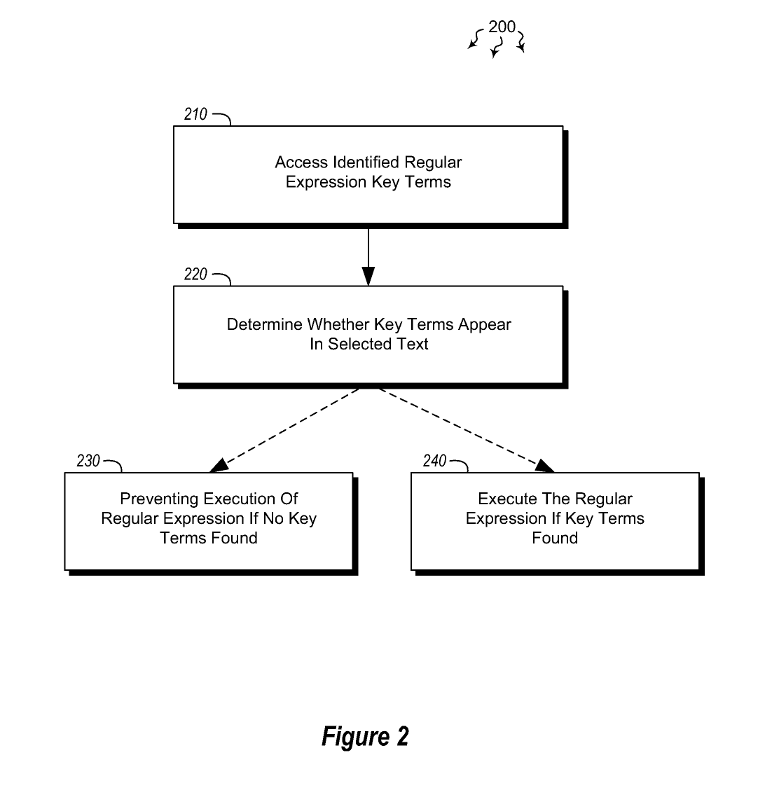

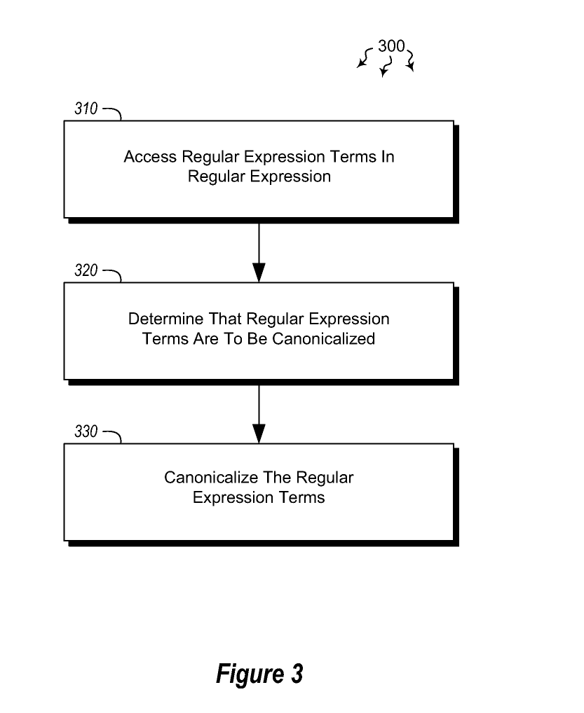

Canonicalization: none, Regular expression: “\w*\s*Some Text.*(?!invalid).*” where positive key terms include {“Some Text”} and negative key terms include {“invalid”}. Negative key terms, as used herein, include terms that, if found, mean that the regular expression cannot match. Thus, in this example, if the term “invalid” is found in the text, the regular expression will not match. These and other concepts will be explained in greater detail below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for conditionally executing regular expressions. The method 200 will now be described with frequent reference to the components and data of environments 100 and 400 of FIGS. 1 and 4, respectively.

Method 200 includes an act of accessing one or more identified regular expression key terms that are to appear in a selected portion of text, wherein the regular expression key terms are identified from terms in a selected regular expression (act 210). For example, key term evaluating module 115 may access identified key terms 111 that are to appear in a selected portion of text (e.g. text 116). The regular expression key terms 111 may be identified by key terms identifying module 110. The regular expression from which the key terms may be identified (e.g. regular expression 105) may include multiple different regular expression terms and regular expression special characters. The key terms may include fundamental terms that, without which, prevent the regular expression from being matched to the selected portion of text. Accordingly, as explained above, if the key terms of the regular expression are not found in the document, then the rest of the regular expression does not need to be executed, as the key terms must be present in the document for a match to occur.

In some cases, identifying regular expression key terms may include parsing only a portion of the regular expression 105 to identify the key terms 111, without parsing the entire regular expression. This may save processing resources by avoiding parsing the entire regular expression. Additionally or alternatively, identifying regular expression key terms may include identifying a group of key terms that, without each key term in the group, prevents the regular expression from being matched to the selected portion of text. In other cases involving groups of terms, if any key term in the group of key terms is matched to the selected portion of text, the match may cause the regular expression to be executed. In such cases, policy may determine matching with groups of terms.

Method 200 includes an act of determining whether the one or more identified regular expression key terms appear in the selected portion of text (act 220). For example, key term evaluating module 115 may determine whether one or more identified key terms 111 appears in the text portion 116. In some cases, the identified key terms may be identified without parsing the entire regular expression. In such cases, the regular expression 105 may be executed using a bounded execution. A bounded execution may execute only portions of the regular expression, based on where the key terms were identified in the regular expression. Data such as metadata may be stored, identifying where in the regular expression each key term was found. Based on this information, regular expression execution module 120 may perform a bounded execution on the regular expression. During such a bounded execution, the execution may start and stop based on where in the regular expression the key terms were found.

In some embodiments, regular expression terms may be canonicalized in the regular expression. As explained above, canonicalizing may reduce the number of terms in the regular expression by converting certain a set of characters to a single character during the processing of a document. In some cases, a user may be able to specify which characters are to be canonicalized in given portion of text or perform other regular expression optimizations.

Method 200 includes, upon determining that none of the identified regular expression key terms appears in the selected portion of text, an act of preventing execution of the regular expression (act 230). For example, if none of the identified regular expression key terms 111 appears in the selected portion of text 116, regular expression execution module 120 may prevent execution of the regular expression. On the other hand, if one or more of the regular expression key terms does appear in the text, execution module 120 may execute the regular expression as planned (act 240). In this manner, execution of a regular expression with no matching key terms may be avoided. Moreover, when key terms do match, the regular expression may be executed as it normally would be.

FIG. 3 illustrates a flowchart of a method 300 for canonicalizing regular expression terms. The method 300 will now be described with frequent reference to the components and data of environments 100 and 400 of FIGS. 1 and 4, respectively.

Method 300 includes an act of accessing one or more regular expression terms in a regular expression, the regular expression being configured for finding desired characters sets in a document (act 310). For example, canonicalization module 435 may access regular expression terms in regular expression 105. In some cases, a user may indicate which regular expression terms are to be canonicalized (e.g. in indication 430). Additionally or alternatively, a software program or other entity may determine which regular expression terms are to be canonicalized for a given regular expression.

Method 300 includes an act of determining that one or more of the regular expression terms are to be canonicalized (act 320). For example, canonicalization module 435 (or another user or software program) may determine that certain regular expression terms are to be canonicalized, or converted from a set of terms to a single term.

Method 300 includes, based on the determination, an act of canonicalizing the regular expression terms, such that at least one previously uncanonicalized regular expression term is simplified into a single, canonicalized term (act 330). Thus, canonicalization module 435 may canonicalize the specified regular expression terms (as specified in indication 430) so that at least one previously uncanonicalized regular expression term is simplified into a single, canonicalized term. The resulting text with canonicalized characters 436 may be sent to key term evaluating module 415 to evaluate key terms in the regular expression and/or may be sent to regular expression execution module 420 for execution of the regular expression that includes the canonicalized terms.

In some cases, the regular expression terms may be canonicalized while the regular expression terms are being identified as key terms. Moreover, in some cases, the regular expression terms may be canonicalized while canonicalized terms are being searched for in the associated text (i.e. in text 416). Thereafter, upon determining that at least one of the searched for canonicalized terms was found in the associated text, the full regular expression may be executed.

Accordingly, systems, methods and computer program products are provided which conditionally execute regular expressions. Moreover, systems, methods and computer program products are provided which simplify regular expressions by canonicalizing regular expression terms.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including a processor and a memory, in a computer networking environment including a plurality of computing systems, a computer-implemented method for conditionally executing regular expressions, the method comprising the following acts:
an act of accessing one or more identified regular expression key terms that are to appear in a selected portion of text, wherein the regular expression key terms are identified from terms in a selected regular expression;
an act of determining whether the one or more identified regular expression key terms appear in the selected portion of text; and
upon determining that none of the identified regular expression key terms appears in the selected portion of text, an act of preventing execution of the regular expression.

2. The method of claim 1, further comprising an act of identifying one or more regular expression key terms in a regular expression.

3. The method of claim 2, wherein the identified regular expression key terms comprise fundamental terms that, without which, prevent the regular expression from being matched to the selected portion of text.

4. The method of claim 1, wherein the selected regular expression comprises a plurality of regular expression terms and regular expression special characters.

5. The method of claim 1, further comprising, upon determining that at least one of the identified regular expression key terms appears in the selected portion of text, an act of executing the regular expression.

6. The method of claim 2, wherein identifying regular expression key terms comprises parsing a portion of the regular expression to identify the key terms, without parsing the entire regular expression.

7. The method of claim 2, wherein identifying regular expression key terms comprises identifying a group of key terms that, without each key term in the group, prevents the regular expression from being matched to the selected portion of text.

8. The method of claim 2, wherein identifying regular expression key terms comprises identifying a group of terms that, if any key term in the group of key terms is matched to the selected portion of text, causes the regular expression to be executed.

9. The method of claim 1, further comprising:
an act of determining that the regular expression was partially parsed, such that not all of the regular expression terms were identified as key terms; and
based on the determination, an act of executing the regular expression using a bounded execution, wherein the bounded execution executes the parsed portion of the regular expression on a subset of the selected portion of text.

10. The method of claim 9, further comprising an act of storing in a data store data relating to where in the regular expression each key term was found.

11. The method of claim 10, wherein the bounded execution starts and stops the execution of the regular expression based on where in the regular expression the key terms were found.

12. The method of claim 1, further comprising:
an act of determining that at least one of the regular expression key terms comprises a negative key term; and
upon finding the negative key term in the selected portion of text, an act of determining that the regular expression does not match the selected text portion.

13. The method of claim 1, further comprising an act of canonicalizing one or more regular expression terms in the regular expression, wherein canonicalizing reduces the number of terms in the regular expression.

14. A computer program product for implementing a method for simplifying regular expressions by canonicalizing regular expression terms, the computer program product comprising one or more computer-readable storage media having stored thereon computer-executable instructions that, when executed by one or more processors of the computing system, cause the computing system to perform the method, the method comprising:
an act of accessing one or more regular expression terms in a regular expression, the regular expression being configured for finding desired characters sets in a document;
an act of determining that one or more of the regular expression terms are to be canonicalized;
based on the determination, an act of canonicalizing the regular expression terms, such that at least one previously uncanonicalized regular expression term is simplified into a single, canonicalized term.

15. The computer program product of claim 14, further comprising an act of canonicalizing one or more portions of text in the document.

16. The computer program product of claim 14, wherein an indication is received from a user indicating which regular expression terms are to be canonicalized.

17. The computer program product of claim 14, wherein the regular expression terms are canonicalized while the regular expression terms are being identified as key terms.

18. The computer program product of claim 14, wherein the regular expression terms are canonicalized while canonicalized terms are being searched for in the associated text.

19. The computer program product of claim 18, further comprising an act of executing the full regular expression upon determining that at least one of the searched for canonicalized terms was found in the associated text.

20. A computer system comprising the following:
one or more processors;
system memory;
one or more computer-readable storage media having stored thereon computer-executable instructions that, when executed by the one or more processors, causes the computing system to perform a method for conditionally executing regular expressions, the method comprising the following:
an act of accessing one or more identified regular expression key term groups that are to appear in a selected portion of text, wherein the regular expression key term groups are identified from terms in a selected regular expression;
an act of canonicalizing one or more regular expression term groups in the regular expression, wherein canonicalizing reduces the number of terms in the regular expression;
an act of determining whether the one or more identified regular expression key term groups appear in the selected portion of text; and
upon determining that at least one of the identified regular expression key term groups appears in the selected portion of text, an act of executing the regular expression which includes a reduced number of terms due to canonicalization.
